(19) United States
(12) Patent Application Publication
(10) Pub. No.: US 2022/0130137 A1
(43) Pub. Date: Apr. 28, 2022

(54) METHOD AND APPARATUS FOR SEARCHING NEURAL NETWORK ARCHITECTURE

(71) Applicant: Fujitsu Limited, Kawasaki-shi (JP)

(72) Inventors: Huigang ZHANG, Beijing (CN); Liuan WANG, Beijing (CN); Jun SUN, Beijing (CN)

(73) Assignee: Fujitsu Limited, Kawasaki-shi (JP)

(21) Appl. No.: 17/571,546

(22) Filed: Jan. 10, 2022

Related U.S. Application Data
(63) Continuation of application No. PCT/CN2019/095967, filed on Jul. 15, 2019.

(51) Int. Cl. G06V 10/776; G06V 10/82; G06N 3/04

(52) U.S. Cl. CPC G06V 10/776; G06N 3/04; G06V 10/82

(57) ABSTRACT

A method and an apparatus for searching a neural network architecture comprising a backbone network and a feature network. The method comprises: a. forming a first search space for the backbone network and a second search space for the feature network; b. using a first controller to sample a backbone network model in the first search space, and using a second controller to sample a feature network model in the second search space; c. combining the first controller and the second controller by adding collected entropy and probability of the sampled backbone network model and feature network model to obtain a combined controller; d. using the combined controller to obtain a combined model; e. evaluating the combined model, and updating a combined model parameter according to an evaluation result; f. determining a verification accuracy of the updated combined model, and updating the combined controller according to the verification accuracy.

### CROSS-REFERENCE TO RELATED APPLICATION

This application is a Bypass continuation of PCT filing PCT/CN2019/095967, filed Jul. 15, 2019, the entire contents of which is incorporated herein by reference.

### FIELD

The present disclosure generally relates to object detection, and in particular relates to a method and an apparatus for automatically searching for a neural network architecture which is used for object detection.

### BACKGROUND

Object detection is a fundamental computer vision task that aims to locate each object and label its class in an image. Nowadays, rely on the rapid progress of deep convolutional network, object detection has achieved much improvement in precision.

Most models for object detection use networks designed for image classification as backbone networks, and then different feature representations are developed for detectors. These models can achieve high detection accuracy, but are not suitable for real-time tasks. On the other hand, some lite detection models that may be used on central processing unit (CPU) or mobile phone platforms have been proposed, but the detection accuracy of these models is often unsatisfactory. Therefore, when dealing with real-time tasks, it is difficult for the existing detection models to achieve a good balance between latency and accuracy.

In addition, some methods of establishing an object detection model through neural network architecture search (NAS) have been proposed. These methods focus on searching for a backbone network or searching for a feature network. The detection accuracy can be improved to a certain extent due to the effectiveness of NAS. However, since these searching methods are aimed at the backbone network or the feature network which is part of the entire detection model, such one-sided strategy still lose detection accuracy.

In view of the above, the current object detection models have the following drawbacks:

1) The state-of-the-art detection models rely on much human work and prior knowledge. They can get high detection accuracy, but are not suitable for real-time tasks.

2) The human designed lite models or pruning models can handle real-time problems, but the accuracy is difficult to meet the requirements.

3) The existing NAS-based methods can obtain a relatively good model for one of the backbone network and the feature network only when the other one of the backbone network and the feature network is given.

### SUMMARY

In view of the above problems, a NAS-based search method of searching for an end-to-end overall network architecture is provided in the present disclosure.

According to one aspect of the present disclosure, it is provided a method of automatically searching for a neural network architecture which is used for object detection in an image and includes a backbone network and a feature network. The method includes the steps of: (a) constructing a first search space for the backbone network and a second search space for the feature network, where the first search space is a set of candidate models for the backbone network, and the second search space is a set of candidate models for the feature network; (b) sampling a backbone network model in the first search space with a first controller, and sampling a feature network model in the second search space with a second controller; (c) combining the first controller and the second controller by adding entropies and probabilities for the sampled backbone network model and the sampled feature network model, so as to obtain a joint controller; (d) obtaining a joint model with the joint controller, where the joint model is a network model including the backbone network and the feature network; (e) evaluating the joint model, and updating parameters of the joint model according to a result of evaluation; (0 determining validation accuracy of the updated joint model, and updating the joint controller according to the validation accuracy; and (g) iteratively performing the steps (d)-(f), and taking a joint model reaching a predetermined validation accuracy as the found neural network architecture.

According to another aspect of the present disclosure, it is provided an apparatus of automatically searching for a neural network architecture which is used for object detection in an image and includes a backbone network and a feature network. The apparatus includes a memory and one or more processors. The processor is configured to: (a) construct a first search space for the backbone network and a second search space for the feature network, where the first search space is a set of candidate models for the backbone network, and the second search space is a set of candidate models for the feature network; (b) sample a backbone network model in the first search space with a first controller, and sample a feature network model in the second search space with a second controller; (c) combine the first controller and the second controller by adding entropies and probabilities for the sampled backbone network model and the sampled feature network model, so as to obtain a joint controller; (d) obtain a joint model with the joint controller, where the joint model is a network model including the backbone network and the feature network; (e) evaluate the joint model, and update parameters of the joint model according to a result of evaluation; (f) determine validation accuracy of the updated joint model, and update the joint controller according to the validation accuracy; and (g) iteratively perform the steps (d)-(f), and take a joint model reaching a predetermined validation accuracy as the found neural network architecture.

According to another aspect of the present disclosure, there is provided a recording medium storing a program. The program, when executed by a computer, causes the computer to perform the method of automatically searching for a neural network architecture as described above.

### BRIEF DESCRIPTION OF THE DRAWINGS

FIG. 1 schematically shows an architecture of a detection network for object detection.

FIG. 2 schematically shows a flowchart of a method of searching for a neural network architecture according to the present disclosure.

FIG. 3 schematically shows an architecture of a backbone network.

FIG. 4 schematically shows output features of the backbone network.

FIG. 5 schematically shows generation of detection features based on the output features of the backbone network.

FIG. 6 schematically shows combination of features and a second search space.

FIG. 7 shows an exemplary configuration block diagram of computer hardwares for implementing the present disclosure.

### DETAILED DESCRIPTION

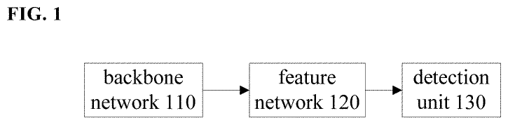

FIG. 1 shows a schematic block diagram of a detection network for object detection. As shown in FIG. 1, the detection network includes a backbone network 110, a feature network 120 and a detection unit 130. The backbone network 110 is a basic network for constructing a detection model. The feature network 120 generates feature representations for detecting an object, based on the output of the backbone network 110. The detection unit 130 detects an object in an image according to the features outputted by the feature network 120, to obtain a position and a class label of the object. The present disclosure mainly relates to the backbone network 110 and the feature network 120, both of which can be implemented by a neural network.

Different from the existing NAS-based method, the method according to the present disclosure aims to search for an overall network architecture including the backbone network 110 and the feature network 120, and therefore is called an end-to-end network architecture search method.

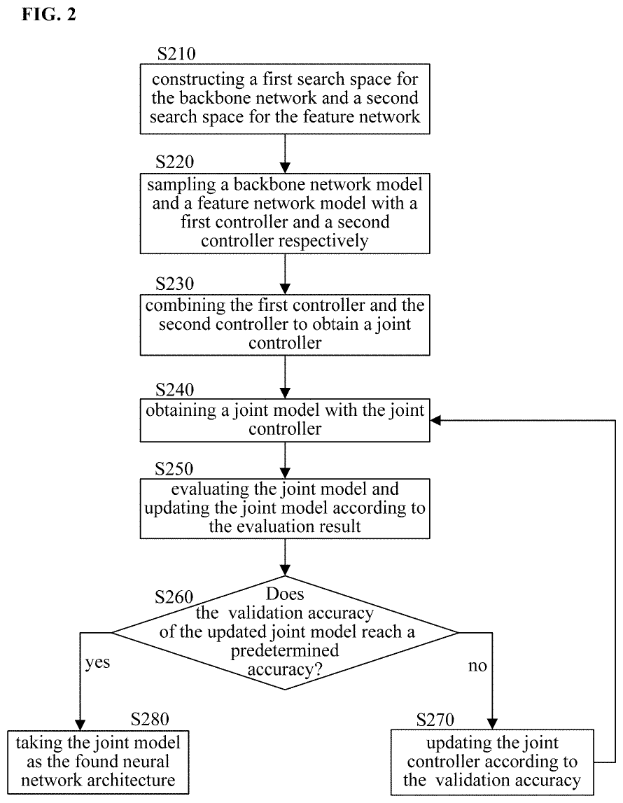

FIG. 2 shows a flowchart of a method of searching for a neural network architecture according to the present disclosure. As shown in FIG. 2, in step S210, a first search space for the backbone network and a second search space for the feature network are constructed. The first search space includes multiple candidate network models for establishing the backbone network, and the second search space includes multiple candidate network models for establishing the feature network. The construction of the first search space and the second search space will be described in detail below.

In step S220, a backbone network model is sampled in the first search space with a first controller, and a feature network model is sampled in the second search space with a second controller. In the present disclosure, “sampling” may be understood as obtaining a certain sample, i.e., a certain candidate network model, in the search space. The first controller and the second controller may be implemented with a recurrent neural network (RNN). “Controller” is a common concept in the field of neural network architecture search, which is used to sample a better network structure in the search space. The general principle, structure and implementation details of the controller are described for example in “Neural Architecture Search with Reinforcement Learning”, Barret Zoph et al., the 5th International Conference of Learning Representation, 2017. This article is incorporated herein by reference.

In step S230, the first controller and the second controller are combined by adding entropies and probabilities for the sampled backbone network model and the sampled feature network model, so as to obtain a joint controller. Specifically, entropy and probability (denoted as the entropy E1 and the probability P1) are calculated for the backbone network model sampled with the first controller, and entropy and probability (denoted as the entropy E2 and the probability P2) are calculated for the feature network model sampled with the second controller. An overall entropy E is obtained by adding the entropy E1 and the entropy E2. Similarly, an overall probability P is obtained by adding the probability P1 and the probability P2. A gradient for the joint controller may be calculated based on the overall entropy E and the overall probability P. In this way, the joint controller which is a combination of two independent controllers may be indicated by the two controllers, and the joint controller may be updated in the subsequent step S270.

Then, in step S240, a joint model is obtain with the joint controller. The joint model is an overall network model including the backbone network and the feature network.

Then, in step S250, the obtained joint model is evaluated. For example, the evaluation may be based on one or more of regression loss (RLOSS), focal loss (FLOSS), and time loss (FLOP). In the object detection, a detection box is usually used to identify the position of the detected object. The regression loss indicates a loss in determining the detection box, which reflects a degree of matching between the detection box and an actual position of the object. The focal loss indicates a loss in determining a class label of the object, which reflects accuracy of classification of the object. The time loss reflects a calculation amount or calculation complexity. The higher the calculation complexity, the greater the time loss.

As a result of the evaluation of the joint model, the loss for the joint model in one or more of the above aspects may be determined. Then, parameters of the joint model are updated in such a way that the loss function LOSS(m) is minimized. The loss function LOSS(m) may be expressed as the following formula:

LOSS(m)=FLOSS(m+λ₁RLOSS(m)+λ₂FLOP(m)

where weight parameters λ₁ and λ₂ are constants depending on specific applications. It is possible to control the degree of effect of the respective losses by appropriately setting the weight parameters λ₁ and λ₂.

Next, validation accuracy of the updated joint model is calculated based on a validation data set, and it is determined whether the validation accuracy reaches a predetermined accuracy, as shown in step S260.

In a case that the validation accuracy has not reached the predetermined accuracy(“No” in step S260), the joint controller is updated according to the validation accuracy of the joint model, as shown in step S270. In this step, for example, a gradient for the joint controller is calculated based on the added entropies and probabilities obtained in step S230, and then the calculated gradient is scaled according to the validation accuracy of the joint model, so as to update the joint controller.

After obtaining the updated joint controller, the process returns to step S240, and the updated joint controller may be used to generate the joint model again. By iteratively performing steps S240 to S270, the joint controller may be continuously updated according to the validation accuracy of the joint model, so that the updated joint controller may generate a better joint model, and thereby continuously improving the validation accuracy of the obtained joint model.

In a case that the validation accuracy reaches the predetermined accuracy in step S260 (“Yes” in step S260), the current joint model is taken as the found neural network architecture, as shown in step S280. The object detection network as shown in FIG. 1 may be established based on the neural network architecture.

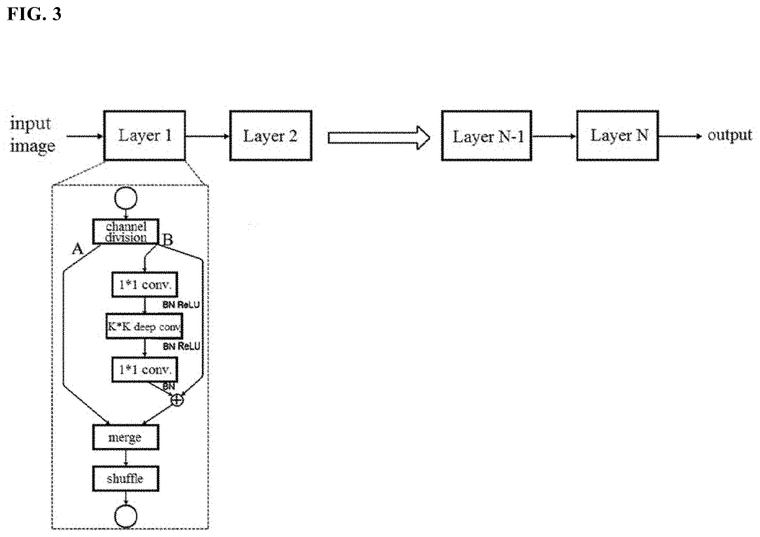

The architecture of the backbone network and the first search space for the backbone network are described in conjunction with FIG. 3 as follows. As shown in FIG. 3, the backbone network may be implemented as a convolutional neural network (CNN) having multiple layers (N layers), and each layer has multiple channels. Channels of each layer are equally divided into a first portion A and a second portion B. No operation is performed on the channels in the first portion A, and residual calculation is selectively performed on the channels in the second portion B. At last the channels in the two portions are combined and shuffled.

In particular, the optional residual calculation is implemented through the connection lines indicated as “skip” in the drawings. When there is a “skip” line, the residual calculation is performed with respect to the channels in the second portion B, and thus the residual strategy and shuffle are combined for this layer. When there is no “skip” line, the residual calculation is not performed, and thus this layer is an ordinary shuffle unit.

For each layer of the backbone network, in addition to the mark indicating whether the residual calculation is to be performed (i.e., presence or absence of the “skip” line), there are other configuration options, such as a kernel size and an expansion ratio for residual. In the present disclosure, the kernel size may be, for example, 3*3 or 5*5, and the expansion ratio may be, for example, 1, 3, or 6.

A layer of the backbone network may be configured differently according to different combinations of the kernel size, the expansion ratio for residual, and the mark indicating whether the residual calculation is to be performed. In a case that the kernel size may be 3*3 and 5*5, the expansion ratio may be 1, 3, and 6, and the mark indicating whether the residual calculation is to be performed may be 0 and 1, there are 2×3×2=12 combinations (configurations) for each layer, and accordingly there are 12^{N} possible candidate configurations for a backbone network including N layers. These 12^{N} candidate models constitute the first search space for the backbone network. In other words, the first search space includes all possible candidate configurations of the backbone network.

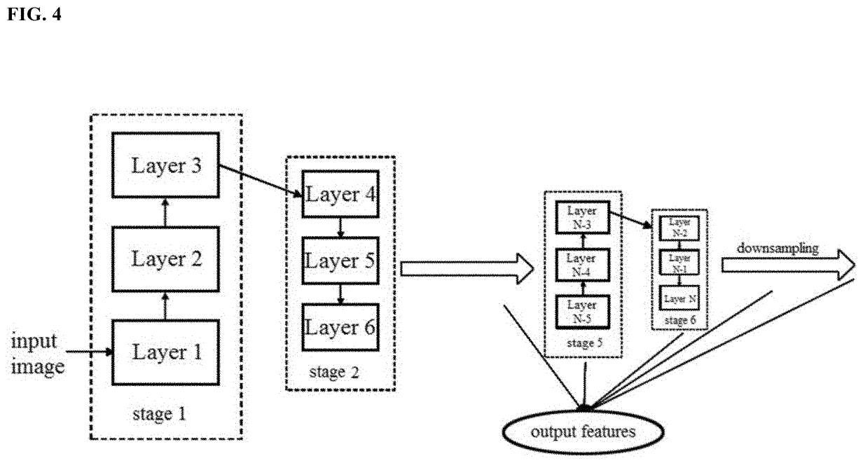

FIG. 4 schematically shows a method of generating the output features of the backbone network. As shown in FIG. 4, the N layers of the backbone network are divided into multiple stages in order. For example, layer 1 to layer 3 are assigned to the first stage, layer 4 to layer 6 are assigned to the second stage, . . . , and layer (N−2) to layer N are assigned to the sixth stage. It should be noted that FIG. 4 only schematically shows a method of dividing the layers, and the present disclosure is not limited to this example. Other division methods are also possible.

Layers in the same stage output features with the same size, and the output of the last layer in a stage is used as the output of that stage. In addition, a feature reduction process is performed every k layers (k=the number of layers included in each stage), so that the size of the feature outputted by the latter stage is smaller than the size of the feature outputted by the former stage. In this way, the backbone network can output features with different sizes suitable for identifying objects with different sizes.

Then, one or more features with a size smaller than a predetermined threshold among the features outputted by the respective stages (for example, the first stage to the sixth stage) are selected. As an example, the features outputted by the fourth stage, the fifth stage and the sixth stage are selected. In addition, the feature with the smallest size among the features outputted by the respective stages is downsampled to obtain a downsampled feature. Optionally, the downsampled feature may be further downsampled to obtain a feature with a further smaller size. As an example, the feature outputted by the sixth stage is downsampled to obtain a first downsampled feature, and the first downsampled feature is downsampled to obtain a second downsampled feature with a size smaller than the size of the first downsampled feature.

Then, the features with a size smaller than a predetermined threshold (such as the features outputted by the fourth stage to the sixth stage) and the features obtained through downsampling (such as the first downsampled feature and the second downsampled feature) are used as the output features of the backbone network. For example, the output feature of the backbone network may have a feature stride selected from the set {16, 32, 64, 128, 256}. Each value in the set indicates a scaling ratio of the feature relative to the original input image. For example, 16 indicates that the size of the output feature is 1/16 of the size of the original image. When applying the detection box obtained in a certain layer of the backbone network to the original image, the detection box is scaled according to the ratio indicated by the feature stride corresponding to the layer, and then the scaled detection box is used to indicate the position of the object in the original image.

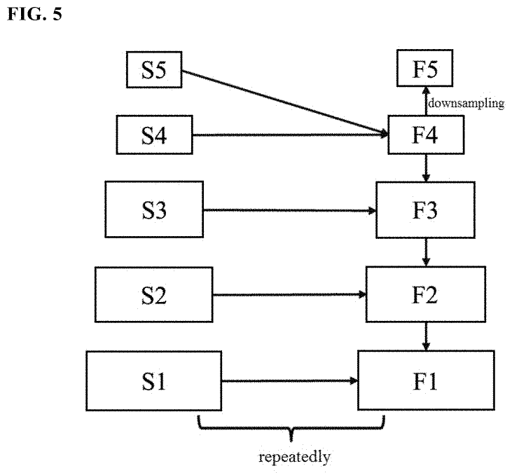

The output features of the backbone network are then inputted to the feature network, and are converted into detection features for detecting objects in the feature network. FIG. 5 schematically shows a process of generating detection features in the feature network based on the output features of the backbone network. In FIG. 5, S1 to S5 indicate five features outputted by the backbone network that gradually decrease in size, and F1 to F5 indicate detection features. It should be noted that the present disclosure is not limited to the example shown in FIG. 5, and a different number of features are also possible.

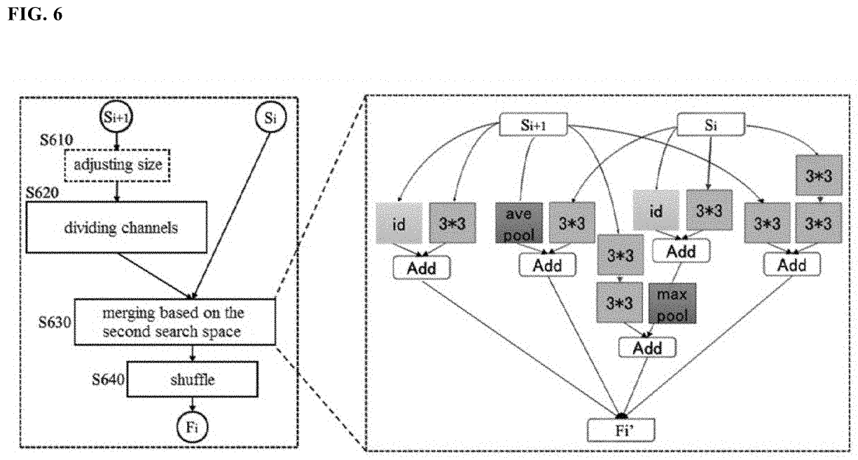

First, the feature S5 is merged with the feature S4 to generate the detection feature F4. The feature merging operation will be described in detail below in conjunction with FIG. 6.

The obtained detection feature F4 is then downsampled to obtain the detection feature F5 with a smaller size. In particular, the size of the detection feature F5 is the same as the size of the feature S5.

Then, the feature S3 is merged with the obtained detection feature F4 to generate the detection feature F3. The feature S2 is merged with the obtained detection feature F3 to generate the detection feature F2. The feature S1 is merged with the obtained detection feature F2 to generate the detection feature F1.

In this way, detection features F1 to F5 for detecting the object are generated by performing merging and downsampling on the output features S1 to S5 of the backbone network.

Preferably, the process described above may be repeatedly performed multiple times to obtain better detection features. Specifically, for example, the obtained detection features F1 to F5 may be further merged in the following manner: merging the feature F5 with the feature F4 to generate a new feature F4′; downsampling the new feature F4′ to obtain a new feature F5′; merging the feature F3 with the new feature F4′ to generate a new feature F3′. . . and so on, in order to obtain the new feature F1′-F5′. Further, the new features F1′-F5′ may be merged to generate detection features F1′ to F5″. This process may be repeated many times, so that the resulted detection features have better performance.

The merging of two features will be described in detail below in conjunction with FIG. 6. The left part of FIG. 6 shows a flow of the merging method. S₁ indicates one of multiple features outputted by the backbone network which gradually decrease in size, and Sᵢ₊₁ indicates the feature that is adjacent to the feature Sᵢ and has a size smaller than the size of the feature Sᵢ (see FIG. 5). Since the feature Sᵢ and the feature Sᵢ₊₁ have different sizes and include different numbers of channels, a certain process is needed before merging in order to make these two features have the same size and the same number of channels.

As shown in FIG. 6, the size of the feature Sᵢ₊₁ is adjusted in step S610. For example, in a case where the size of the feature Sᵢ is twice the size of the feature Sᵢ₊₁, the size of the feature Sᵢ₊₁ is increased twice its original size in step S610.

In addition, in a case where the number of channels in the feature Sᵢ₊₁ is twice the number of channels in the feature Sᵢ, the channels of the feature Sᵢ₊₁ are divided in step S620, and a half of its channels are merged with the feature Sᵢ.

Merge may be implemented by searching for the best merging manner in the second search space, and merging the feature Sᵢ₊₁ and the feature Sᵢ in the found best manner, as shown in step S630.

The right part of FIG. 6 schematically shows construction of the second search space. At least one of the following operations may be performed on each of the feature Sᵢ₊₁ and the feature Sᵢ: 3*3 convolution, two-layer 3*3 convolution, max pooling (max pool), average pooling (ave pool) and no operation (id). Then, results of any two operations are added (add), and a predetermined number of the results of addition are added to obtain the feature Fi′.

The second search space includes various operations performed on the feature Sᵢ₊₁ and the feature Sᵢ and various addition methods. For example, FIG. 6 shows that results of two operations (such as id and 3*3 convolution) performed on the feature Sᵢ₊₁ are added, results of two operations (such as id and 3*3) performed on the feature Sᵢ are added, result of an operation (such as average pooling) performed on the feature Sᵢ₊₁ and result of an operation (such as 3*3 convolution) performed on the feature Sᵢ are added, result of a single operation (such as two-layer 3*3 convolution) performed on the feature Sᵢ₊₁ and result of multiple operations (such as 3*3 convolution and max pooling) performed on the feature Sᵢ are added, and the four results of addition are added to obtain the feature Fi′.

It should be noted that FIG. 6 only schematically shows construction of the second search space. In fact, the second search space includes all possible manners of processing and merging the feature Sᵢ₊₁ and the feature Si. The processing of step S630 is to search for the best merging manner in the second search space, and then merge the feature Sᵢ₊₁ and the feature Sᵢ in the found manner. In addition, each of the possible merging manners here corresponds to a feature network model sampled in the second search space with the second controller as described above in conjunction with FIG. 2. It involves not only which node is to operated, but also what kind of operation is to be performed on the node.

Then, in step S640, channel shuffle is performed on the obtained feature Fi′, so as to obtain the detection feature Fi.

The embodiments of the present disclosure have been described in detail above with reference to the accompanying drawings. Compared with the human designed lite model and the existing NAS-based model, the searching method according to the present disclosure can obtain an overall architecture of a neural network (including the backbone network and the feature network), and has the following advantages: the backbone network and the feature network can be updated at the same time, so as to ensure an overall good output of the detection network; it is possible to handle multi-task problems and balance accuracy and latency during the search due to the use of multiple losses (such as RLOSS, FLOSS, FLOP); since lightweight convolution operation is used in the search space, the found model is small and thus is especially suitable for mobile environments and resource-limited environments.

The method described above may be implemented by hardware, software or a combination of hardware and software. Programs included in the software may be stored in advance in a storage medium arranged inside or outside an apparatus. In an example, these programs, when being executed, are written into a random access memory (RAM) and executed by a processor (for example, CPU), thereby implementing various processing described herein.

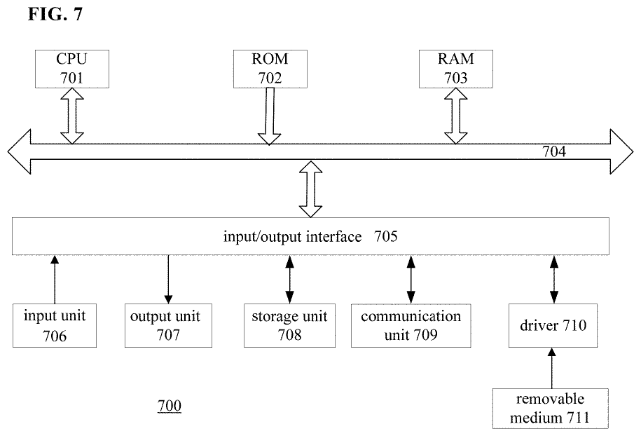

FIG. 7 is a schematic block diagram showing computer hardware for performing the method according to the present disclosure based on programs. The computer hardware is an example of the apparatus for automatically searching for a neural network architecture according to the present disclosure.

In a computer 700 as shown in FIG. 7, a central processing unit (CPU) 701, a read-only memory (ROM) 702, and a random access memory (RAM) 703 are connected to each other via a bus 704.

An input/output interface 705 is connected to the bus 704. The input/output interface 705 is further connected to the following components: an input unit 706 implemented by keyboard, mouse, microphone and the like; an output unit 707 implemented by display, speaker and the like; a storage unit 708 implemented by hard disk, nonvolatile memory and the like; a communication unit 709 implemented by network interface card (such as local area network (LAN) card, and modem); and a driver 710 that drives a removable medium 711. The removable medium 711 may be for example a magnetic disk, an optical disk, a magneto-optical disk or a semiconductor memory.

In the computer having the above structure, the CPU 701 loads a program stored in the storage unit 708 into the RAM 703 via the input/output interface 705 and the bus 704, and executes the program so as to perform the method described in the present disclosure.

A program to be executed by the computer (CPU 701) may be recorded on the removable medium 711 which is a package medium, including a magnetic disk (including floppy disk), an optical disk (including compact disk-read only memory (CD-ROM)), a digital versatile disk (DVD), and the like), a magneto-optical disk, or a semiconductor memory, and the like. Further, the programs to be executed by the computer (the CPU 701) may also be provided via wired or wireless transmission media such as local area network, Internet or digital satellite broadcast.

When the removable medium 711 is loaded in the driver 710, the programs may be installed into the storage unit 708 via the input/output interface 705. In addition, the program may be received by the communication unit 709 via a wired or wireless transmission medium, and then the program may be installed in the storage unit 708. Alternatively, the programs may be pre-installed in the ROM 702 or the storage unit 708.

The program executed by the computer may be a program that performs operations in the order described in the present disclosure, or may be a program that performs operations in parallel or as needed (for example, when called).

The units or devices described herein are only logical and do not strictly correspond to physical devices or entities. For example, the functionality of each unit described herein may be implemented by multiple physical entities or the functionality of multiple units described herein may be implemented by a single physical entity. In addition, the features, components, elements, steps and the like described in one embodiment are not limited to this embodiment, and may also be applied to other embodiments, such as replacing specific features, components, elements, steps and the like in other embodiments or being combined with specific features, components, elements, steps and the like in other embodiments.

The scope of the present disclosure is not limited to the specific embodiments described herein. Those skilled in the art should understand that, depending on design requirements and other factors, various modifications or changes may be made to the embodiments herein without departing from the principle and spirit of present disclosure. The scope of the present disclosure is defined by the appended claims and equivalents thereof.

### Appendix:

(1). A method of automatically searching for a neural network architecture which is used for object detection in an image and includes a backbone network and a feature network, the method including the steps of:

(a) constructing a first search space for the backbone network and a second search space for the feature network, wherein the first search space is a set of candidate models for the backbone network, and the second search space is a set of candidate models for the feature network;

(b) sampling a backbone network model in the first search space with a first controller, and sampling a feature network model in the second search space with a second controller;

(c) combining the first controller and the second controller by adding entropies and probabilities for the sampled backbone network model and the sampled feature network model, so as to obtain a joint controller;

(d) obtaining a joint model with the joint controller, wherein the joint model is a network model including the backbone network and the feature network;

(e) evaluating the joint model, and updating parameters of the joint model according to a result of evaluation;

(f) determining validation accuracy of the updated joint model, and updating the joint controller according to the validation accuracy; and

(g) iteratively performing the steps (d)-(f), and taking a joint model reaching a predetermined validation accuracy as the found neural network architecture.

(2). The method according to (1), further including:

calculating a gradient for the joint controller based on the added entropies and probabilities;

scaling the gradient according to the validation accuracy, so as to update the joint controller.

(3). The method according to (1), further including: evaluating the joint model based on one or more of regression loss, focal loss and time loss.

(4). The method according to (1), wherein the backbone network is a convolutional neural network having multiple layers,

wherein channels of each layer are equally divided into a first portion and a second portion,

wherein no operation is performed on the channels in the first portion, and residual calculation is selectively performed on the channels in the second portion.

(5). The method according to (4), further including: constructing the first search space for the backbone network based on a kernel size, an expansion ratio for residual, and a mark indicating whether the residual calculation is to be performed.

(6). The method according to (5), wherein the kernel size includes 3*3 and 5*5, and the expansion ratio includes 1, 3 and 6.

(7). The method according to (1), further including: generating detection features for detecting an object in the image based on output features of the backbone network, by performing merging operation and downsampling operation.

(8). The method according to (7), wherein the second search space for the feature network is constructed based on an operation to be performed on each of two features to be merged and a manner of merging the operation results.

(9). The method according to (8), wherein the operation includes at least one of 3*3 convolution, two-layer 3*3 convolution, max pooling, average pooling and no operation.

(10). The method according to (7), wherein the output features of the backbone network include N features which gradually decrease in size, the method further includes:

merging an N-th feature with an (N−1)-th feature, to generate an (N−1)-th merged feature;

performing downsampling on the (N−1)-th merged feature, to obtain an N-th merged feature;

merging an (N−i)-th feature with an (N−i+1)-th merged feature, to generate an (N−i)-th merged feature, wherein i=2, 3, . . . , N−1; and

using the resulted N merged features as the detection features.

(11) The method according to (7), further including:

dividing multiple layers of the backbone network into multiple stages in sequence, wherein the layers in the same stage output features with the same size, and the features outputted from the respective stages gradually decrease in size;

selecting one or more features with a size smaller than a predetermined threshold among the features outputted from the respective stages, as a first feature;

downsampling the feature with the smallest size among the features outputted from the respective stages, and taking the resulted feature as a second feature;

using the first feature and the second feature as the output features of the backbone network.

(12) The method according to (1), wherein the first controller, the second controller, and the joint controller are implemented by a recurrent neural network (RNN).

(13) The method according to (8), further including: before merging the two features, performing processing to make the two features have the same size and the same number of channels.

(14). An apparatus for automatically searching for a neural network architecture which is used for object detection in an image and includes a backbone network and a feature network, wherein the apparatus includes a memory and one or more processors configured to perform the method according to (1)-(13).

(15). A recording medium storing a program, wherein the program, when executed by a computer, causes the computer to perform the method according to (1)-(13).

1. A method of automatically searching for a neural network architecture which is used for object detection in an image and comprises a backbone network and a feature network, the method comprising the steps of:
(a) constructing a first search space for the backbone network and a second search space for the feature network, wherein the first search space is a set of candidate models for the backbone network, and the second search space is a set of candidate models for the feature network;
(b) sampling a backbone network model in the first search space with a first controller, and sampling a feature network model in the second search space with a second controller;
(c) combining the first controller and the second controller by adding entropies and probabilities for the sampled backbone network model and the sampled feature network model, so as to obtain a joint controller;
(d) obtaining a joint model with the joint controller, wherein the joint model is a network model comprising the backbone network and the feature network;
(e) evaluating the joint model, and updating parameters of the joint model according to a result of evaluation;
(f) determining validation accuracy of the updated joint model, and updating the joint controller according to the validation accuracy; and
(g) iteratively performing the steps (d)-(f), and taking a joint model reaching a predetermined validation accuracy as the found neural network architecture.

2. The method according to claim 1, further comprising:
calculating a gradient for the joint controller based on the added entropies and probabilities;
scaling the gradient according to the validation accuracy, so as to update the joint controller.

3. The method according to claim 1, further comprising: evaluating the joint model based on one or more of regression loss, focal loss and time loss.

4. The method according to claim 1, wherein the backbone network is a convolutional neural network having a plurality of layers,
wherein channels of each layer are equally divided into a first portion and a second portion,
wherein no operation is performed on the channels in the first portion, and residual calculation is selectively performed on the channels in the second portion.

5. The method according to claim 4, further comprising: constructing the first search space for the backbone network based on a kernel size, an expansion ratio for residual, and a mark indicating whether the residual calculation is to be performed.

6. The method according to claim 5, wherein the kernel size comprises 3*3 and 5*5, and the expansion ratio comprises 1, 3 and 6.

7. The method according to claim 1, further comprising: generating detection features for detecting an object in the image based on output features of the backbone network, by performing merging operation and downsampling operation.

8. The method according to claim 7, wherein the second search space for the feature network is constructed based on an operation to be performed on each of two features to be merged and a manner of merging the operation results.

9. The method according to claim 8, wherein the operation comprises at least one of 3*3 convolution, two-layer 3*3 convolution, max pooling, average pooling and no operation.

10. The method according to claim 7, wherein the output features of the backbone network comprise N features which gradually decrease in size, and the method further comprises:
merging an N-th feature with an (N−1)-th feature, to generate an (N−1)-th merged feature;
performing downsampling on the (N−1)-th merged feature, to obtain an N-th merged feature;
merging an (N−i)-th feature with an (N−i+1)-th merged feature, to generate an (N−i)-th merged feature, where i=2, 3, . . . , N−1; and
using the resulted N merged features as the detection features.
